(19) United States
(12) Patent Application Publication
(10) Pub. No.: US 2004/0210729 A1
(43) Pub. Date: Oct. 21, 2004

(54) Nonvolatile memory

(75) Inventors: Takashi Horii, Higashimurayama (JP); Keiichi Yoshida, Musashimurayama (JP); Atsushi Nozoe, Hino (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 10/484,634

(22) PCT Filed: Jun. 7, 2002
(86) PCT No.: PCT/JP02/05641

(30) Foreign Application Priority Data
Jul. 23, 2001 (JP) 2001-220956

(51) Int. Cl. G06F 12/00

(52) U.S. Cl. 711/156

(57) ABSTRACT

A nonvolatile memory, provided with nonvolatile memory cells, has a plurality of memory banks each of which can perform memory operations independently of others, and a control unit for controlling the memory operations of the memory banks. The control unit is capable of controlling an interleave operation by which, even during a memory operation in response to an operational instruction designating one of the memory banks, a memory operation in response to another operational instruction designating another memory bank can be started, and a parallel operation by which both memory banks are caused to perform memory operations in parallel when, before a memory operation in response to an operational instruction designating one of the memory banks is started, another memory operation designating another memory bank is instructed. Each memory bank is provided with a status register, and the status of memory operation in each memory bank is reflected in the corresponding status register.

### BACKGROUND OF THE INVENTION

The present invention relates to a nonvolatile memory of a multi-bank form, and more particularly to an electrically rewritable flash memory for use in a file memory system or the like.

A flash memory is a kind of nonvolatile memory into which information can be stored by injecting electrons into or extracting electrons from its floating gates. A flash memory consists of memory cell transistors (flash memory cells) each having a floating gate, a control gate, a source and a drain. In this memory cell transistor, the threshold voltage rises when electrons are injected into the floating gate, and the threshold voltage falls when electrons are extracted from the floating gate. Thus the memory cell transistor stores information according to the level of the threshold voltage relative to the word line voltage (voltage applied to the control gate) for data reading. In this specification, a state in which the threshold voltage of the memory cell transistor is low will be referred to as an erase state and a state in which the threshold voltage is high, as a write state, though the description is not necessarily bound by this terminology.

In order to achieve the write state or the erase state, it is necessary, while gradually applying a predetermined high voltage to memory cell transistors, to check whether or not a predetermined threshold voltage has been reached, and this processing takes a much longer time than a read operation. Furthermore, there may arise an abnormal state in which the intended threshold voltage level cannot be attained on account of a deterioration in the characteristics of memory cell transistors. A flash memory can give an external notice of its busy state during a write operation or an erase operation by externally supplying a ready/busy signal, permits referencing from outside via status registers for any abnormality due to the write or erase operation. The host apparatus issues no access command to a flash memory in a busy state and, if it has detected any abnormality in a write operation via a status register, controls such operations as write retrial. The host apparatus, when it has detected any abnormality in an erase operation via a status register, performs replacement of a storage area in the flash memory for instance.

References containing descriptions of flash memories include the Japanese Unexamined Patent Publication No. Hei 11(1999)-232886 and the Japanese Unexamined Patent Publication No. Hei 11(1999)-345494.

### SUMMARY OF THE INVENTION

The present inventors have studied a flash memory in a multi-bank form in which a plurality of memory banks are provided on a single semiconductor chip. A memory bank is a circuit block having a plurality of flash memory cells and capable of operating as a memory independent of other memory banks. The inventors have studied the possibility of writing in parallel or erasing in parallel in the plurality of memory banks of such a flash memory of a multi-bank form in order to reduce the duration of the busy state due to an erase operation or a write operation.

The study revealed that a flash memory of a multi-bank form cannot serve the purpose by merely mounting single-memory bank flash memories on a single chip.

First, if any write error or erase error has occurred, unless it is made perceivable from outside in which memory bank the error has occurred, operations including write retrial should be done on both of the memory banks, resulting in waste of time in otherwise unnecessary processing and wasteful electrical stresses in the memory cell transistors, which would reduce their useful lives.

Second, it has been found that if this problem is addressed by adding many dedicated commands for parallel writing or parallel erasing in multiple banks, the overall command system or the logical scale of command deciphering may become too large.

Third, if a write error or an erase error arises in a multi-bank flash memory, it will be necessary on the part of the memory controller to find out in which memory bank of the multiple banks the error has arisen and to address the problem accordingly. This makes the idea no different from mere mounting of single-memory bank flash memories on a single chip in the sense that the processing load on the part of the memory controller is increased.

Therefore, an object of the present invention is to provide a nonvolatile memory having multiple banks permitting external identification of the memory bank in which any access error has occurred.

Another object of the invention is to provide a nonvolatile memory having multiple banks permitting a reduction, even if an access error, such as a write or erase error, occurs in any multiple bank inside, in the load on the part of the memory controller for processing against that error.

Still another object of the invention is to provide a nonvolatile memory, such as flash memory, having multiple banks permitting parallel write operations and parallel erase operations on a plurality of memory banks.

Yet another object of the invention is to provide a nonvolatile memory, such as flash memory, having multiple banks permitting a reduction in the duration of the busy state due to an erase operation or a write operation.

Another object of the invention is to provide a nonvolatile memory capable of restraining a dimensional increase in the overall command system or the logical command deciphering in allowing a plurality of memory banks to operate in parallel.

The above-described and other objects and novel features of the present invention will become more apparent from the following description in this specification when taken in conjunction with the accompanying drawings.

Typical aspects of the invention disclosed in this application will be briefly described below.

(1) [Multi-bank multi-status register] A nonvolatile memory has, over a semiconductor substrate, a plurality of memory banks provided with nonvolatile memory cells in which stored information is rewritable and each of which can perform memory operations independently of others, a control unit for controlling the memory operations on the plurality of memory banks, status registers of which one is provided for each of the memory banks, and an interface unit for interfacing with outside. The control unit controls the memory operations on each memory bank in accordance with operational instructions, causes status information indicating the status of memory operations to be reflected in the status register of the corresponding memory bank, and enables the status information reflected in the status register to be supplied externally from the interface unit. This makes it possible to identify externally the memory bank in which any access error has occurred.

As the memory operations, an operation to erase stored information in nonvolatile memory cells, an operation to write information into the nonvolatile memory cells, and an operation to read stored information out of the nonvolatile memory cells are possible. The items of the status information in this connection include erase check information indicating the presence or absence of abnormal erase resulting from the erase operation and write check information indicating the presence or absence of abnormal write resulting from the write operation.

The control unit, when the status information indicates abnormality in writing, makes acceptable, for the memory bank pertaining to that abnormality in writing, only predetermined ones out of instructions specified for that memory bank. For instance, the predetermined instructions may include a write retry instruction by which the memory bank pertaining to the abnormality in writing is designated and a write operation is repeated and a status register reset instruction by which the status register of the memory bank pertaining to the abnormality in writing is reset. The predetermined instructions may also include a recovery read instruction by which the memory bank pertaining to the abnormality in writing is designated and write data pertaining to the abnormality in writing are externally supplied. This arrangement makes it possible, even if a write access error occurs in multiple banks, can provide protection against any inadequate instruction from a memory controller to remedy that error, and thereby contribute to enhancing the reliability of memory operation and reducing the load on the memory controller.

Further the control unit, when the status information indicates abnormality in erasion, makes acceptable, for the memory bank pertaining to that abnormality in erasion, only predetermined ones out of operational instructions specified for that memory bank. For instance, the predetermined instructions may include a status register reset instruction by which the status register of the memory bank pertaining to the abnormality in erasion is reset. This arrangement makes it possible, even if an erase access error occurs in multiple banks, can provide protection against any inadequate instruction from a memory controller to remedy that error, and thereby contribute to enhancing the reliability of memory operation and reducing the load on the memory controller.

Each of the memory banks may have a substitution circuit for relieving nonvolatile memory cells contained in the memory bank from any defect that may have occurred.

(2) [Parallel operation and interleave operation of multiple banks] A nonvolatile memory has, over a semiconductor substrate, a plurality of memory banks provided with nonvolatile memory cells in which stored information is rewritable and each of which can perform memory operations independently of others, and a control unit for controlling the memory operations on the plurality of memory banks. The control unit controls the memory operations on each memory bank in accordance with operational instructions, and is capable of controlling an interleave operation by which, even during a memory operation in response to an operational instruction designating one of the memory banks, a memory operation in response to another operational instruction designating another memory bank can be started, and a parallel operation by which both memory banks are caused to perform memory operations in parallel when, before a memory operation in response to an operational instruction designating one of the memory banks is started, another memory operation designating another memory bank is instructed. Therefore, accessing for write operation or erase operation can be carried out on a plurality of memory banks in parallel. This feature makes it possible to reduce the duration of a busy state due to an erase operation and a write operation.

An operation to erase stored information in nonvolatile memory cells, an operation to write information into the nonvolatile memory cells, and an operation to read stored information out of the nonvolatile memory cells are possible as the memory operations. Then, the interleave operation and parallel operation are made possible for the instruction of an erase operation or for instruction of a write operation.

The control unit determines, for an instruction of a write operation, whether to make possible the interleave operation or to make possible the parallel operation according to a difference in command code.

The control unit determines, for an instruction of an erase operation, whether to make possible the interleave operation or to make possible the parallel operation according to whether only one memory bank or a plurality of memory banks are designated.

(3) More specific aspects of a nonvolatile memory from the above-stated points of view permitting a parallel operation and an interleave operation on multiple banks will now be identified from the viewpoint of access commands. A nonvolatile memory has, over a semiconductor substrate, a plurality of memory banks provided with nonvolatile memory cells in which stored information is rewritable and each of which can perform memory operations independently of others, and a control unit for controlling the memory operations on the plurality of memory banks in accordance with access commands from outside. The access commands include a first access command and a second access command. The first access command contains a first command code, address information designating an address in one of the memory banks, a second command code, address information designating an address in another memory bank, and the second command code. The second access command contains a first command code, address information designating an address in one of the memory banks, a third command code, address information designating an address in another memory bank, and the second command code. The control unit starts, in response to the inputting of the second command code, a memory operation on the memory bank designated by the address information.

For instance, the first command code is a command code to represent the type of the write operation, and the second command code is a command code to instruct the start of the write operation. Supposing a write control logic according to which if, for example, the write address in a write operation is to be designated by an X address and a Y address and, if the Y address is not designated, writing is to be done from the leading position of the sector designated by the X address, a third command code may be preceded either only by the X address or by the X address and the Y address, and therefore delimitation from address information intended for accessing another memory bank is made clear by the third command code.

The first access command is used for instructing the interleave operation, and the second access command is used for instructing the parallel operation. The second access command differs from the first access command only in the third command code, and the first command code and the second command code are used in common. Therefore, even if the control mode of parallel operation of multiple banks is adopted in combination with that of interleave operation, the increase in commands can be restrained, and accordingly the logical scale of command deciphering can be prevented from becoming too large.

Now is supposed a case in which there are a third access command and a fourth access command as access commands, different from the case described above. The third access command contains a fourth command code, address information designating an address in one of the memory banks, and a fifth command code. The fourth access command contains a fourth command code, address information designating an address in one of the memory banks, address information designating an address in another memory bank, and said fifth command code. The control unit starts, in response to the inputting of said fifth command code, a memory operation on the memory bank designated by said address information. For instance, the fourth command code is a command code to instruct an erase operation, and the fifth command code is a command code to instruct the start of an erase operation. If erasion is to be carried out sector by sector, each sector being designated by an X address, the address information will be free from the ambiguity, unlike in writing, that the Y address is sometimes contained and at other times not, and therefore no delimiter such as the third command code need not be arranged in the access command. Where access commands of this form are to be used, as in the above-described case, even if the control mode of parallel operation of multiple banks is adopted in combination with that of interleave operation, the increase in commands can be restrained, and accordingly the logical scale of command deciphering can be prevented from becoming too large.

### BRIEF DESCRIPTIONS OF THE INVENTION

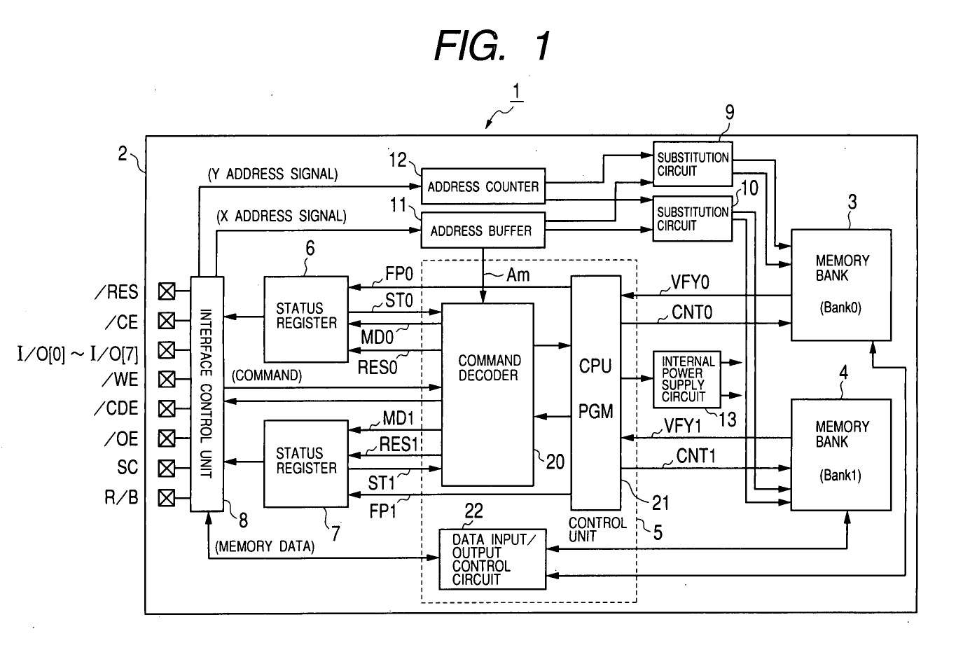

FIG. 1 is a block diagram of a flash memory, which is an example of nonvolatile memory according to the present invention.

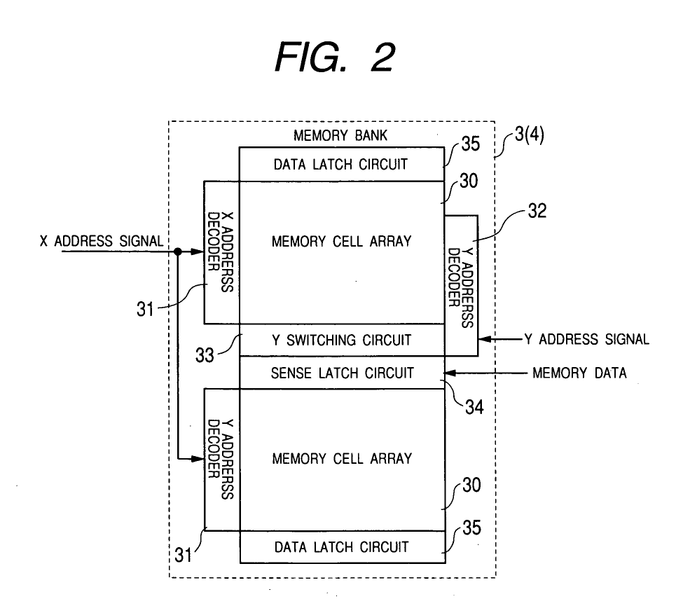

FIG. 2 is a block diagram of an example of memory bank.

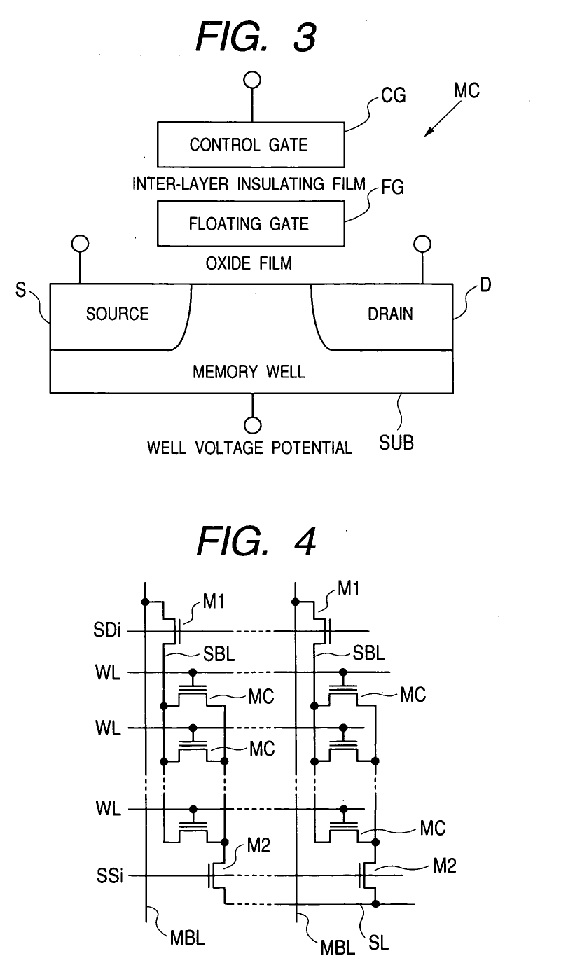

FIG. 3 illustrates an example of sectional structure of a nonvolatile memory cell.

FIG. 4 is a circuit diagram illustrating part of an AND type memory cell array.

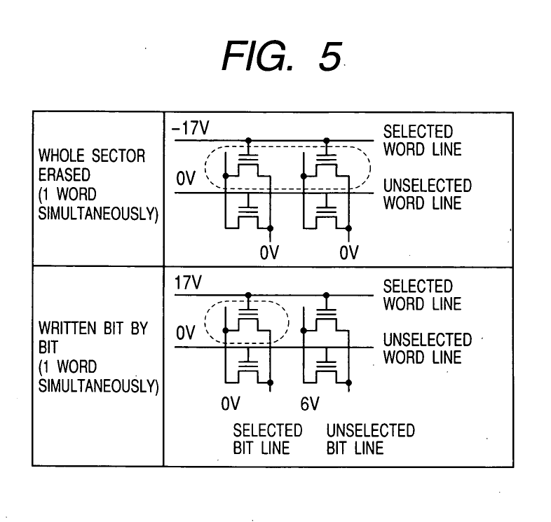

FIG. 5 illustrates an example of state of voltage application to a memory cell for erasion and writing.

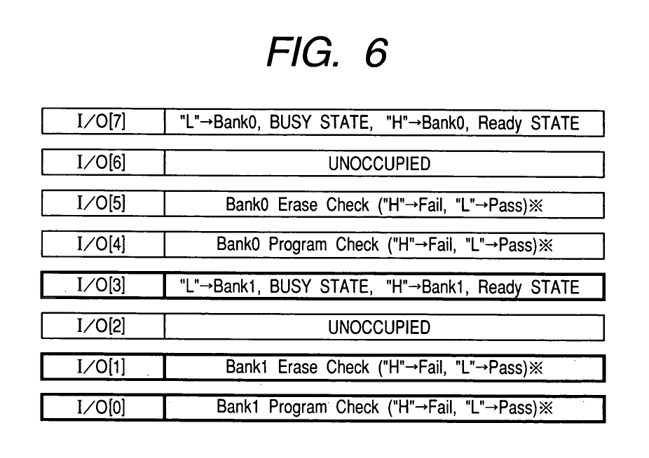

FIG. 6 illustrates an example of allocation of output terminals for information held by status registers.

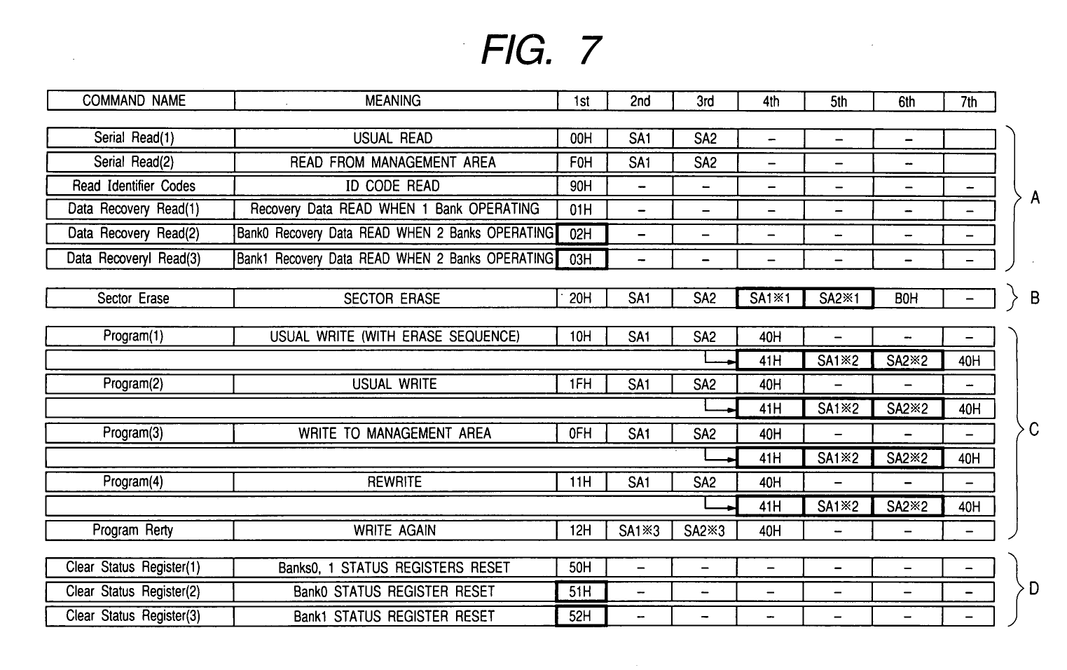

FIG. 7 illustrates examples of commands to a flash memory.

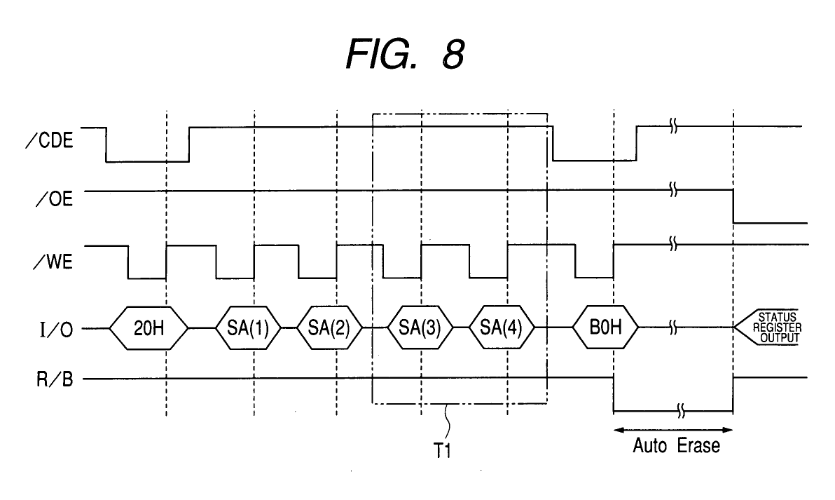

FIG. 8 is a timing chart of parallel erase operation on two memory banks.

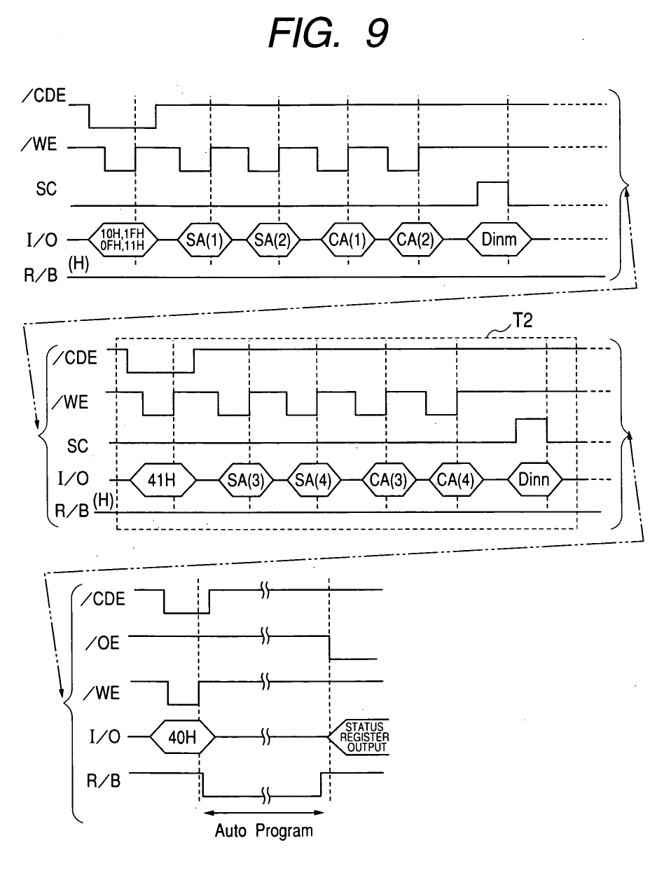

FIG. 9 is a timing chart of parallel write operation on two memory banks.

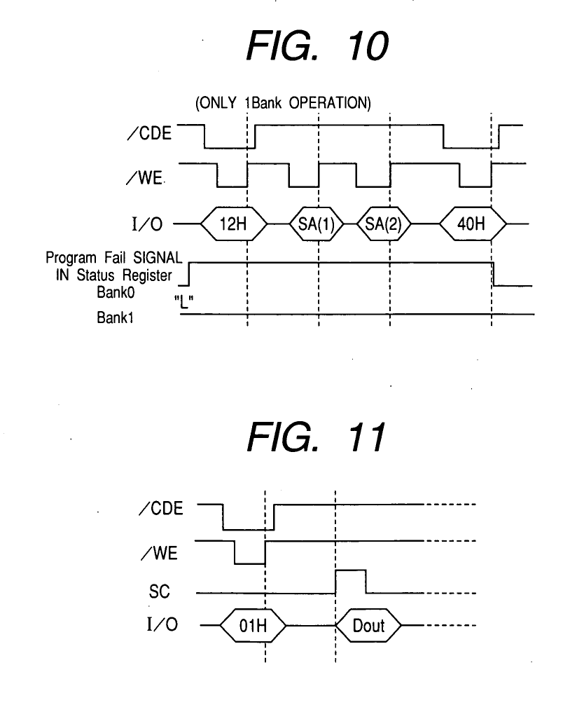

FIG. 10 is a timing chart of an operation by a write retry command.

FIG. 11 is a timing chart of an operation by a recovery read command in one-memory bank operation.

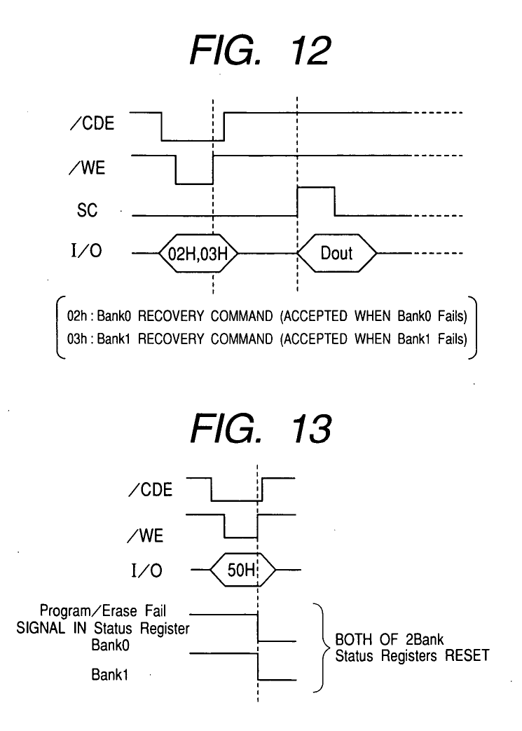

FIG. 12 is a timing chart of an operation by a recovery read command in two-memory bank operation.

FIG. 13 is a timing chart of collective resetting operation on a status register for each individual memory bank.

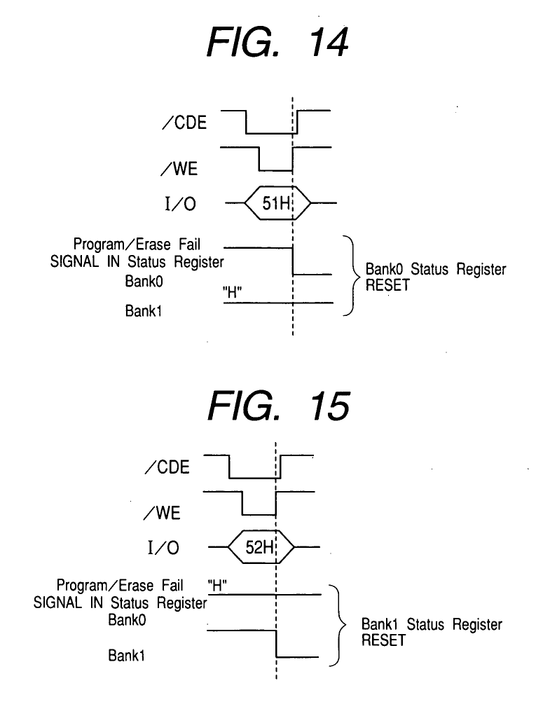

FIG. 14 is a timing chart of reset operation on one of the status registers for the memory banks.

FIG. 15 is a timing chart of reset operation on the other of the status registers for the memory banks.

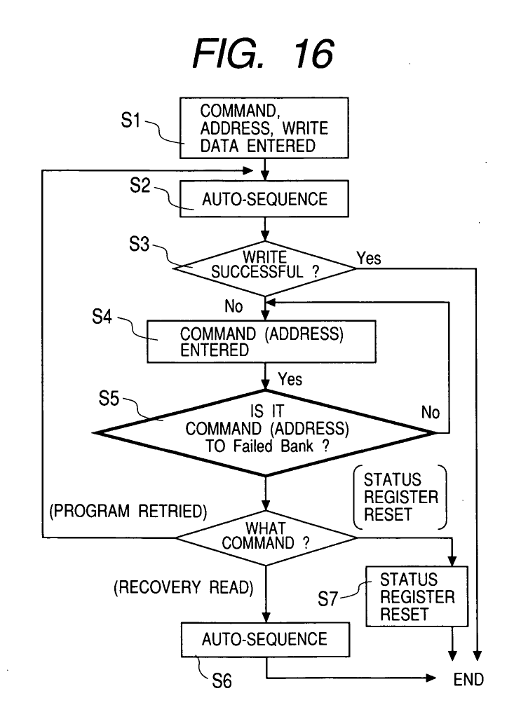

FIG. 16 is a flow chart of operations of the command decoder and the CPU when a write failure has occurred.

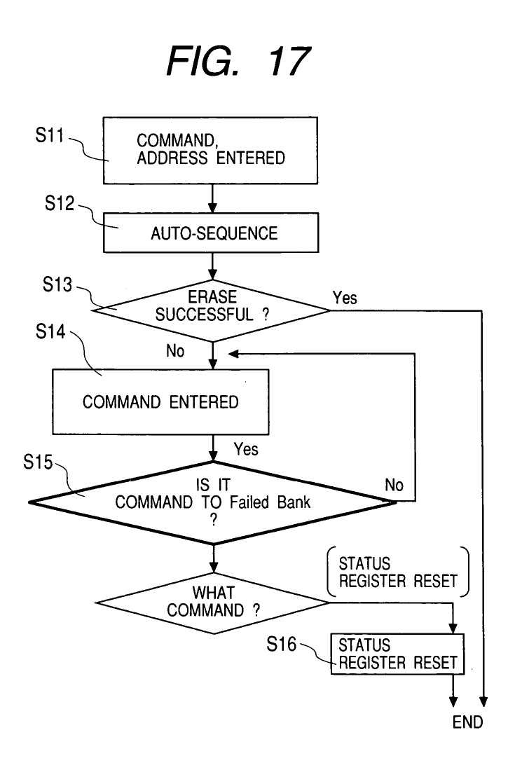

FIG. 17 is a flow chart of operations of the command decoder and the CPU when an erase failure has occurred.

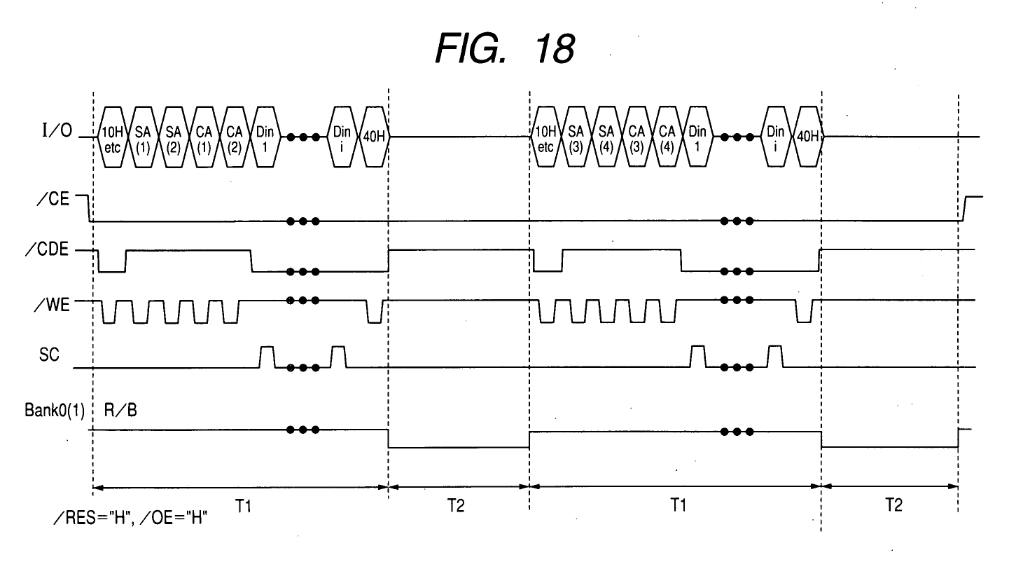

FIG. 18 is a timing chart of one-bank operation by which one memory bank is operated at a time (1 Bank operation).

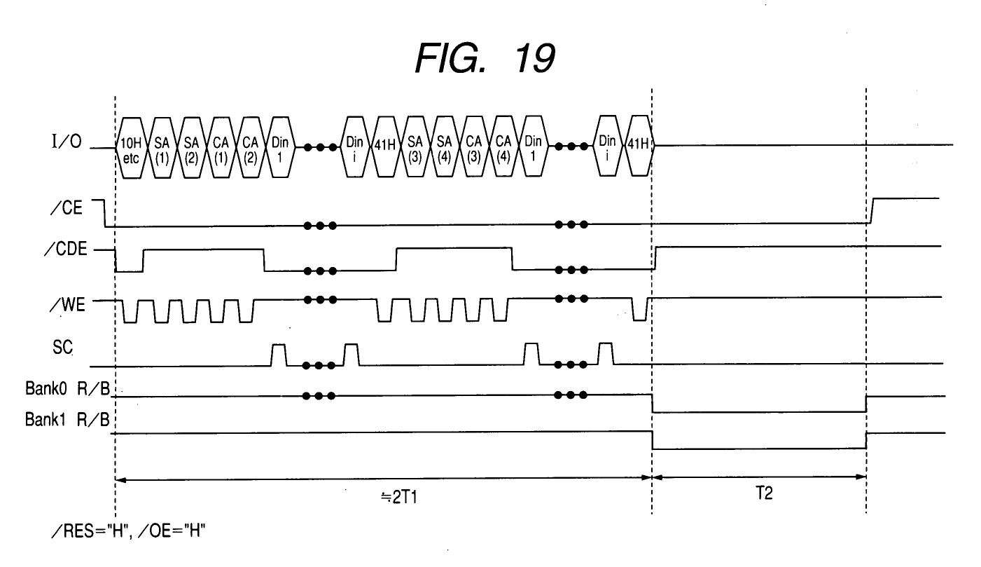

FIG. 19 is a timing chart of writing into two banks in parallel (2 Bank simultaneous writing).

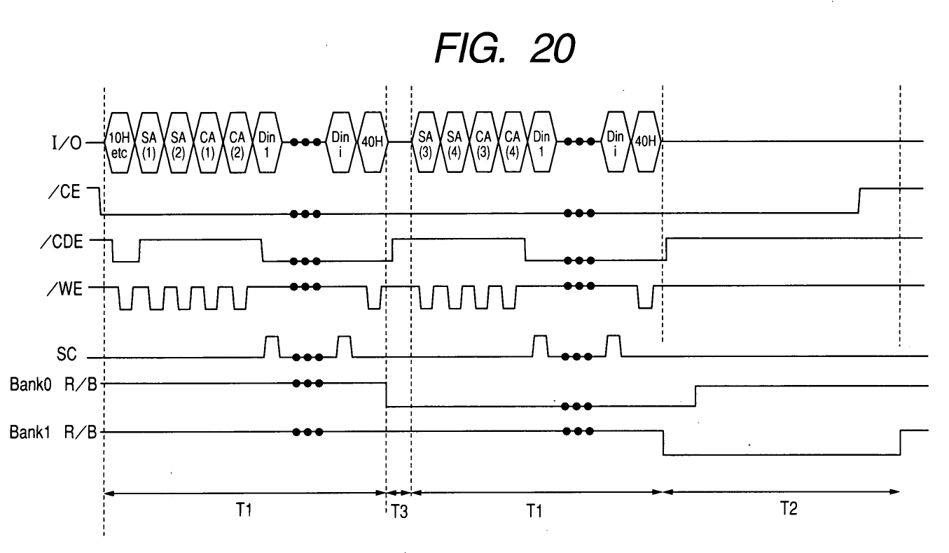

FIG. 20 is a timing chart of interleave write operation.

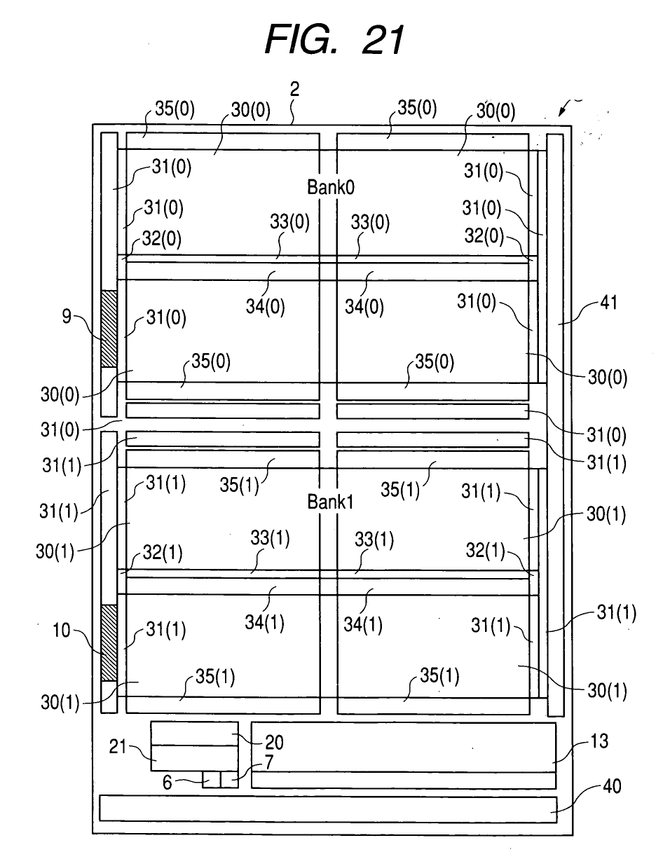

FIG. 21 shows a schematic plan of a typical chip layout of a flash memory.

### DETAILED DESCRIPTION OF THE PREFERRED EMBODIMENT

[Overall configuration of flash memory] FIG. 1 shows an overall view of a flash memory, which is an example of nonvolatile memory according to the present invention.

The flash memory 1 has, over a single semiconductor substrate (semiconductor chip) 2 of monocrystalline silicon or the like, a plurality of, for instance two, memory banks 3 and 4 each capable of operating as a memory independent of the other, a control unit 5 for controlling the memory operation of the two memory banks 3 and 4, status registers 6 and 7 each provided for one or the other of the memory banks 3 and 4, a control unit 8 for interface with outside, substitution circuits 9 and 10 each allocated to one or the other of the memory banks 3 and 4, an address buffer 11, an address counter 12 and an internal power supply circuit 13. The control unit 5 comprises a command decoder 20, a central processing unit (CPU) and a processor 21 having its operation program memory (PGM) (the processor may be simply referred to as the CPU) 21, and a data input/output control circuit 22. The memory bank 3 may also be referred to as Bank0, and the memory bank 4, as Bank1.

The flash memory 1 has external input/output terminals I/Os (I/O [0] through I/O [7]), which are used for multiple purposes including address inputting, data inputting/outputting and command inputting. X address signals entered from the external input/output terminals I/O [0] through I/O [7] are supplied to the X address buffer 11 via the interface control unit 8, and Y address signals entered therefrom are preset in the Y address counter 12 via the interface control unit 8. Commands entered from the external input/output terminals I/O [0] through I/O [7] are supplied to the command decoder 20 via the interface control unit 8. Data entered from the external input/output terminals I/O [0] through I/O [7] to be written into the memory banks 3 and 4 are provided to the data input/output control circuit 22 via the interface control unit 8. Read data from the memory banks 3 and 4 are provided from the data input/output control circuit 22 to the external input/output terminals I/O [0] through I/O [7] via the interface control unit 8. Incidentally, signals entered into or supplied from the input/output terminals I/O [0] through I/O [7] may sometimes be referred to as signals I/O [0] through I/O [7] for the sake of convenience.

The interface control unit 8 enters as access control signals a chip enable signal /CE, an output enable signal /OE, a write enable signal /WE, a serial clock signal SC, a reset signal /RES and a command enable signal /CDE. The sign/immediately preceding the name of each signal means that the signal is a row enable signal. The interface control unit 8 controls signal interfacing with outside and other functions according to the states of those signals. Command inputs from the input/output terminals I/O [0] through I/O [7] are synchronized with the command enable /CDE. The data input is synchronized with the serial clock SC. The input of address information is synchronized with the write enable signal /WE. The interface control unit 8, when the start of an erase or write operation is instructed by a command code, asserts a ready/busy signal R/B indicating that an erase or write operation is taking place while it is on, and supplies it externally.

Each of the memory banks 3 and 4 has many nonvolatile memory cells in which the stored information can be rewritten. Some of the nonvolatile memory cells are reserved as substitute (redundant) memory cells to replace any defective memory cells that may be found. Each of the substitution circuits 9 and 10 has a programming circuit (not shown) that can program the address of any defective memory cell that has to be replaced with a substitute memory cell and an address comparator (not shown) for determining whether or not the programmed address that has to be substituted for has been designated as the access address. X address signals for selecting nonvolatile memory cells out of the memory banks 3 and 4 are supplied from the address buffer 11, while Y address signals for selecting nonvolatile memory cells out of the memory banks 3 and 4 are supplied from the address counter 12. Each X address signal and the Y address signal are supplied to the substitution circuits 9 and 10 and, if the pertinent address is to be substituted for, the address will be replaced or, if not, they are supplied through to the memory banks 3 and 4.

Each of the memory banks 3 and 4 has a memory cell array 30, an X address decoder 31, a Y address decoder 32, a Y switching circuit 33, a sense latch circuit 34, a data latch circuit 35 and so forth as shown in FIG. 2, though its constituent elements are not limited to these. The memory cell array 30 has many electrically erasable and writable nonvolatile memory cells. As shown in FIG. 3, a nonvolatile memory cell MC is configured of a source S and a drain D formed in a semiconductor substrate or a memory well SUB, a floating gate FG formed in the channel area with an oxide film interposed therebetween, and a control gate CG stacked over the floating gate FG with an inter-layer insulating film interposed therebetween. In the memory cell array 30, where it is an AND type array as shown in FIG. 4, sub-bit lines SBL, represented by typical examples therein, are connected to the main bit lines MBL via a selective MOS transistor M1, and the drains of the nonvolatile memory cells MC are connected to the sub-bit lines SBL. The sources of the nonvolatile memory cells MC which share the sub-bit lines SBL are conned in common to a source line SL via a second selective MOS transistor M2. The first selective MOS transistor M1 is switch-controlled by a bit line control line SDi from one row direction to the other, and the second selective MOS transistor M2 is switch-controlled by a source line control line SSi from one row direction to the other.

The X address decoder 31 shown in FIG. 2 decodes an X address signal, and selects word lines WL, the bit line control line SDi and the source line control line SSi according to the designated memory operation. The Y address decoder 32 decodes a Y address signal supplied from the address counter 12, and generates a switching control signal for the Y switching circuit 33 for bit line selection. The data latch circuit 35 holds write data. The sense latch circuit 34 senses and holds stored information read out of nonvolatile memory cells, and also holds write control data for write operation provided by the data latch circuit 35.

Erasion of data in the memory cells is carried out collectively word line by word line (which also means sector by sector) as shown in FIG. 5 by applying −17 V to selected word lines, 0 V to unselected word lines and 0 V to the source line.

Writing into memory cells is accomplished as shown in FIG. 5 by applying 17 V to word lines selected for writing, 0 V to bit lines selected for writing and 6 V for bit lines unselected for writing. As the duration of the application of the high write voltage is extended the threshold voltage of the memory cells is raised. Whether to apply 0 V or 6 V to bit lines is determined by the logical value of the write control information to be latched to the sense latch circuit.

Reading of data out of the memory cells is accomplished, though this is not the only way, by applying 3.2 V to word lines selected for reading, establishing continuity of the source line to the ground voltage of the circuit, and 1.0 V to bit lines via the sense latch circuit. The stored information is read out according to variations in bit line potential with the presence or absence of currents flowing from the bit lines to the source line correspondingly to the threshold voltage of the memory cells.

Continuity of bit lines selected by the Y address decoder 32 to the data input/output control circuit 22 is established.

Connections between the data input/output control circuit 22 and the input/output terminals I/O [0] through I/O [7] are controlled by the interface control unit 8.

The internal power supply circuit 13 shown in FIG. 1 generates various operating power supplies for writing, erasion, verification, reading and so forth, and supplies them to the memory banks 3 and 4.

The command decoder 20 and the CPU 21 perform overall control over the operations of the flash memory in accordance with commands and the like supplied from the interface control unit 8. Details will be described afterwards. The command decoder 20 and the CPU 21, responding to a command given from outside, carries out erase or write operation in parallel (parallel operation) on the two memory banks 3 and 4 or, even if one of the two memory banks 3 and 4 is under erase or write operation, can perform erase or write operation on the other of the memory banks 3 and 4 in parallel (interleave operation).

The command contains one or more command codes, address information, data information and the like necessary for the execution of the command in a predetermined format, though its contents are not particularly limited to these. Data information, such as write data, contained in the command is supplied to the data input/output control circuit 22. Address information contained in the command is supplied, as described above, to the address buffer 11 and, if necessary, the address counter 12. The memory banks 3 and 4 are mapped to memory addresses different from each other, and an X address signal supplied to the address buffer 11 is positioned as a sector address designating one of sectors of, for instance, 2048 bits each. Especially some of the information contained in the X address signal, especially the most significant address bit Am is deemed to be memory bank designating information to indicate the memory bank to perform a memory operation, and is supplied to the command decoder 20. The command decoder 20 instructs the CPU 21 to have the memory bank indicated by that memory bank designating information perform the memory operation. The Y address signal supplied to the address counter 12 designates positions in eight-bit units for the 2048-bit data of the designated sector address by the X address signal. In the initial state of a memory operation, the address counter 12 is reset to its initial count “0”. When the Y address signal is supplied to this, its value is made the preset count of the address counter 12. The Y address counter 12, with its initial count or preset count as the starting address, supplies Y address signals, successively incremented as required, to the memory banks 3 and 4.

The command decoder 20 shown in FIG. 1 deciphers the command code contained in the command, determines, according to the memory bank designating information Am, which of the memory banks is to be operated, and provides the results of deciphering and determination to the CPU 21. On the basis of those results, the CPU 21 supplies access control signals CNT0 and CNT1 to the memory bank 3 or 4 to be operated to control the operation of the memory bank 3 or 4. When the memory operation is to erase or to write, the application of a high voltage is accomplished in a stepwise manner, verification is done at each step, and verify result information items VFY 0 and VFY 1 are returned to the CPU 21. The CPU 21, if the verify result information items VFY 0 and VFY 1 indicate a state in which a required threshold voltage has not yet been reached, instructs the application of a high voltage at the next step with access control signals CNT0 and CNT1 unless it is a time-out. If the verify result information items VFY 0 and VFY 1 still indicate a state of not yet arriving at the required threshold voltage even when a time-out has come, the CPU 21 will give the status registers 6 and 7 a Fail state according to Fail/Pass information items FP0 and FP1. The command decoder 20 supplies the status registers 6 and 7 with operating mode information items MD0 and MD1 conforming to the operation indicated by the command given at that time. The status registers 6 and 7 identify the Fail/Pass factor notified by the Fail/Pass information items FP0 and FP1 according to the operating mode information items MD0 and MD1, and sets a Fail or Pass state on the corresponding register bit. The command decoder 20 enters status information items ST0 and ST1 held by the status registers 6 and 7, and determines whether or not to accept a newly entered command with reference to them. For instance, if writing into the memory bank (Bank0) has failed, any access command designating that memory bank can be accepted only if it is a predetermined command instructing a write retrial or the like.

The status registers 6 and 7 hold information indicating the state of memory operation by each memory bank. The contents held by the two status registers 6 and 7 can be read out from the input/output terminals I/O [0] through I/O [7] by asserting the output enable signal /OE. The correspondence between the input/output terminals I/O [0] through I/O [7] and their respective output contents is shown in FIG. 6. I/O [0] through I/O [3] are for the memory bank (Bank1), and I/O [4] through I/O are for the memory bank (Bank0). I/O [4] supplies the result of check-up on a write into the memory bank 3 (Bank0); “H” means that the write ended abnormally (Fail) and “L”, that the write ended normally (Pass). I/O [5] supplies the result of check-up on an erase of data in the memory bank 3 (Bank0); “H” means that the erase ended abnormally (Fail) and “L”, that the erase ended normally(Pass). I/O [7] supplies the current operating state of the memory bank 3(Bank0); “H” means a busy state (in write or erase operation) and “L”, a ready state (a new write or erase operation acceptable). The output functions of I/O [0] through I/O [3] are similar to the above-described.

[Commands to flash memory] FIG. 7 illustrates examples of commands to the flash memory. The commands can be broadly classified into commands A for read operations, commands B for erase operations, commands C for write operations and commands D for status register clearing. FIG. 7 shows the names and meanings of commands, and the basic patterns of command formats.

A first serial read command (Serial Read (1)) is a read command for the data area of a sector. A second serial read command (Serial Read (2)) is a read command for the management area of a sector. An ID read command (Read Identifier Codes) is a read command for the storage capacity and the silicon signature, such as a manufacture number, of the flash memory chip. A first data recovery read command (Data Recovery Read (1)) instructs, during an operation to write into one of the memory banks, to cause write data held by the memory bank suffering a write failure to be supplied outside. A second data recovery read command (Data Recovery Read (2))instructs, during an operation to write into the two memory banks, to cause write data held by one memory bank 3 (Bank0) suffering a write failure to be supplied outside. A third data recovery read command (Data Recovery Read (3)) instructs, during an operation to write into the two memory banks, to cause write data held by the other memory bank 4 (Bank1) suffering a write failure to be supplied outside. These data recovery commands are used, when a write failure has occurred, to cause write data held within the flash memory to be supplied outside so as to enable the host apparatus to write them into another flash memory.

A sector erase command (Sector Erase) instructs an erase operation on a sector-by-sector basis.

A write command (Program (1))instructs a write operation with a sector erase sequence. A second write command (Program (2)) instructs an operation to write into the data area of a sector. A third write command (Program (3)) instructs an operation to write into the management area of a sector. A fourth write command (Program (4)) instructs an additional write. The additional write is an operation to write into a partial storage area of the like of the management area A program retry command (Program Retry) instructs, when a write failure has occurred, to retry an operation to write into another sector of the same memory bank.

A status register first reset command (Clear Status Register(1)) instruct the status registers 6 and 7 of both memory banks 3 and 4 (Bank0 and Bank1) to clear (reset) the stored information. A status register second reset command (Clear Status Register (2)) instructs the status register 6 of one memory bank 3 (Bank0) to clear (reset) the stored information. A status register third reset command (Clear Status Register (3)) instructs the status register 7 of the other memory bank 4 (Bank1) to clear (reset) the stored information.

In the leading position of each of the commands described above is arranged a hexadecimal command code, such as “00H”. Some commands, including an ID read command (Read Identifier Codes), consists only of a command code each. In a command requiring address information, the command code is followed by sector address information items SA1 and SA2. Each of the sector address information items SA1 and SA2 consists of 16 bits in total, and the 16 bits constitute one sector address (X address information). Where a read or write operation concerns only a part of one sector and the read or write operation is to begin in the middle of a sector, though not illustrated in FIG. 7, Y address information can be added following the sector address information. Where write data are needed as in a write operation, the Y address information is followed by the write data.

In the sector erase command, a command code “B0H” is to instruct the start of an erase operation. For a command to instruct sector erasion in one memory bank, the command code “B0H” can be added after the addresses SA1 and SA2 of the sectors to be erased. To instruct sector erasion in parallel in two memory banks, second sector address information items SA*l and SA*2 can be arranged after the first sector address information items SA1 and SA2, with the command code “B0H” added at the end. The memory banks designated by the second sector address information items SA1*1 and SA2*1 should be different from the memory banks designated by the first sector address information items SA1 and SA2. No delimiter code is needed between the first sector address information items SA1 and SA2 and the second sector address information items SA1*1 and SA2*1, because neither Y address information nor data information is necessary in sector erasion.

In the first through fourth write commands and program retry commands, a command code “40H” is to instruct the start of a write operation. In writing into two memory banks in parallel, command codes “41H” should intervene as delimiter codes between instructive information items including addresses and write data directed to both memory banks 3 and 4. In a write operation, such delimiter codes are needed because the Y address (preset address to the address counter) can be designated as desired. This delimiter code “41H” can be deemed to be a command code to instruct parallel write operation. In the write operation, the memory banks designated by the second sector address information items SA1*1 and SA2*1 should be different from the memory banks designated by the first sector address information items SA1 and SA2. This two-bank parallel write command has nothing to do with an interleave operation. For a program retry command, a bank having suffered a write failure should be selected for sector addresses SA1*3 and SA2*3. Whether or not these constraints are met is determined by the command decoder 20.

[Parallel erasion in two memory banks] FIG. 8 is a timing chart of parallel erase operation on two memory banks. Following a command code “20H”, the first sector addresses SA(1) and SA(2) and the second sector addresses SA(3) and SA(4) are entered with the command code “B0H” added at the end. The command decoder 20, after detecting the inputting of the command code “20H”, recognizes the memory bank designated by memory bank designating information Am contained in the sector addresses SA(1) and SA(2), and supplies the sector addresses SA(1) and SA(2) to that memory bank. Then, the command decoder 20 recognizes the memory bank designated by memory bank designating information Am contained in the following sector addresses SA(3) and SA(4), and supplies the sector addresses SA(3) and SA(4) to that memory bank. If the memory banks designated by the two sets sector addresses are different, the CPU 21 will be caused to execute parallel erase operation on the sectors designated by the respective sector addresses on condition of the inputting of the command code “B0H”. The CPU 21 executes an erase operation program stored in a ROM to carry out the erase operation (AutoErase). The result of the erase operation is set in the status registers 6 and 7 separately for the memory banks 3 and 4. If the two sets of sector addresses designate the same memory bank, no erase operation will start, and an erase failure will be set in the status registers 6 and 7. Completion of the erase operation can be externally perceived with a ready/busy signal R/B and, when the output enable signal /OE is activated, information in the status registers 6 and 7 is externally supplied via the input/output terminals I/O [0] through I/O [7].

In an erase operation on a single memory bank, the T1 part in FIG. 8 is dispensed with.

[Parallel writing into two memory banks] FIG. 9 is a timing chart of parallel write operation on two memory banks. For instance, following a command code “10H”, the first sector addresses SA(1) and SA(2) and first Y addresses CA(1) and CA(2) are entered. The command decoder 20, after detecting the inputting of the command code “10H”, supplies the sector addresses SA(1) and SA(2) to the memory bank designated by bank designating information contained in the first sector addresses SA(1) and SA(2) and, in synchronism with the counting (synchronized with a serial clock SC) by the address counter 12 preset by the first Y addresses CA(1) and CA(2), enters write data Din(m) supplied in synchronism with the serial clock SC into the corresponding memory bank. The number of write data Din (m) entered can be as desired with an upper limit of one sector equivalent. Then a delimiter code “41H” for a second bank is entered, and the second sector addresses SA(3) and SA(4) and second Y addresses CA(3) and CA(4) are entered. The command decoder 20 recognizes the memory bank designated by memory bank designating information Am contained in the sector addresses SA(3) and SA(4); if it is found different from the memory bank designated by the sector addresses SA(1) and SA(2), supplies the sector addresses SA(3) and SA(4) to the memory bank designated by the sector addresses SA(3) and SA(4); and in synchronism with the counting (synchronized with a serial clock SC) by the address counter 12 preset by the second Y addresses CA(3) and CA(4), enters write data Din(m) supplied in synchronism with the serial clock SC into the corresponding memory bank. Finally, when the command code “40H” is entered, the command decoder 20 causes the CPU 21 to execute parallel write operation on the sectors designated by the sector addresses supplied to both memory banks 3 and 4. The CPU 21 executes a write operation program stored in a ROM to carry out the parallel write operation (AutoProgram). The result of the write operation is set in the status registers 6 and 7 separately for the memory banks 3 and 4. If the two sets of sector addresses designate the same memory bank, no write operation will start, and a write failure will be set in the status registers 6 and 7. Completion of the write operation can be externally perceived with the ready/busy signal R/B and, when the output enable signal /OE is activated, information in the status registers 6 and 7 is externally supplied via the input/output terminals I/O [0] through I/O [7].

The operational timing shown in FIG. 9 also applies to a write command having write command codes of “1FH”, “0FH” and “11H”. In a write operation on a single memory bank, the T2 part in FIG. 9 is dispensed with.

[Write retry operation] FIG. 10 is a timing chart of an operation by a write retry command. The write retry command consists of a command code “12H”, sector addresses SA(1) and SA(2), and a command code “40H” to instruct the start of writing. The command decoder 20 accepts, where the sector addresses SA(1) and SA(2) accompanying the write retry command are sector addresses of the same memory bank as the memory bank in which a write failure has occurred. The write retry command calls for operation on each individual memory bank.

[Recovery read operation] FIG. 11 is a timing chart of an operation by a recovery read command in one-memory bank operation. The command decoder 20, when it has detected the inputting of command code “01H” in a state in which a write failure has occurred in one-memory bank write operation, reads write data pertaining to the write failure out of a data latch circuit, for instance, in the memory bank in which the write failure occurred in the one-memory bank write operation, and externally supplies the data as Dout. The state in which the write failure occurred in the one-memory bank write operation is perceived by the command decoder 20 on the basis of information items ST0 and ST1 from the status registers 6 and 7.

FIG. 12 is a timing chart of an operation by a recovery read command in two-memory bank operation. The command decoder 20, when it has detected the inputting of command code “02H” in the memory bank 3 (Bank0) in a state in which a write failure has occurred in two-memory bank write operation, reads write data pertaining to the write failure out of a data latch circuit, for instance, in the memory bank 3 (Bank0) in which the write failure occurred in the two-memory bank write operation, and externally supplies the data as Dout. Further, the command decoder 20, when it has detected the inputting of command code “03H” in the memory bank 4 (Bank1) in a state in which a write failure has occurred in two-memory bank write operation, reads write data pertaining to the write failure out of a data latch circuit, for instance, in the memory bank 4 (Bank1) in which the write failure has occured, and externally supplies the data as Dout. In which of the memory banks in two-memory bank write operation the write failure has occurred is perceived by the command decoder 20 on the basis of information items ST0 and ST1 from the status registers 6 and 7.

[Status register resetting operation] FIG. 13 is a timing chart of resetting operation on both of the status registers 6 and 7. The command decoder 20 causes the CPU 21 to reset the values of both of the status registers 6 and 7 to “L” by deciphering a command code “50H”.

FIG. 14 is a timing chart of reset operation on the status register 6 for the memory bank Bank0. The command decoder 20, when it has detected the inputting of a command code “51H” in a state in which a write failure or an erase failure has occurred in the memory bank 3 (Bank0), causes the CPU 21 to reset the value of the status register 6 of the memory bank 3.

FIG. 15 is a timing chart of reset operation on the status register 8 of the memory bank Bank1. The command decoder 20, when it has detected the inputting of a command code “52H” in a state in which a write failure or an erase failure has occurred in the memory bank 4 (Bank1), causes the CPU 21 to reset the value of the status register 7 of the memory bank 4.

Incidentally, in which of the memory banks the write failure or the erase failure has occurred is perceived by the command decoder 20 on the basis of information items ST0 and ST1 from the status registers 6 and 7.

[Operations at the time of failure occurrence] FIG. 16 is a flow chart of operations of the command decoder and 20 and the CPU 21 when a write failure has occurred. Command codes, an address and write data are entered (S1), and the CPU 21 executes an auto-sequence of writing into a designated memory bank (S2).

It is judged whether or not the writing is successful (S3) and, if successful, the command processing will be ended. Or if it is unsuccessful (write failure), the next command input will be awaited (S4); it is judged whether or not the input command is a predetermined command code; and, if the command requires designation of a sector address, it will be judged whether or not the sector address pertaining to the failure is designated (S5) In response to the inputting of a predetermined command, it is for a program retry, the process will return to step S2; if it is a recovery read command, auto-programming of its read operation will be executed (S6); or if it is a status register reset command, a reset operation will take place (S7).

FIG. 17 is a flow chart of operations of the command decoder 20 and the CPU 21 when an erase failure has occurred. Command codes and an address are entered (S11), and the CPU 21 executes an auto-sequence of erasion of data in a designated memory bank (S12). It is judged whether or not the erasion is successful (S13) and, if successful, the command processing will be ended. Or if it is unsuccessful (erase failure), the next command input will be awaited (S14); it is judged whether or not the input command is a predetermined command code; and, if the command requires designation of a sector address, it will be judged whether or not the sector address pertaining to the failure is designated (S15). In response to the inputting of a predetermined command, if it is a status register reset command, a reset operation will take place (S16).

[Parallel operation and interleave operation] FIG. 18 is a timing chart of one-bank operation by which one memory bank is operated at a time (1 Bank operation). The write data are supposed to be Din1 through Dini. In FIG. 18, a time period T2 corresponding to the period of write operation (period of busy state for write operation) at the first write command. Subsequent write operation commands are issued after the ready/busy signal R/B is returned to the ready state. T1 is the period of command issuance. Write operations are performed in series on each of the memory banks 3 and 4.

FIG. 19 is a timing chart of writing into two banks in parallel (2 Bank simultaneous writing). Although it takes about twice as long a time as T2 to enter a command, the duration of the operations of the two memory banks 3 and 4 needs no longer time than T2 because the operations take place in parallel.

FIG. 20 is a timing chart of interleave write operation.

The two-bank parallel operation is to cause both memory banks to perform write operations in parallel when, before a memory operation in response to an instruction of write operation designating one of the memory banks is started, another write operation designating the other memory bank is instructed. Unlike this, an interleave write operation means making possible, even during a memory operation in response to an instruction of write operation designating one of the memory banks, memory operation in response to an instruction of write operation designating the other memory bank. A period of time T3 is the length of time from the issuance of a command code “40H” instructing write operation until the issuance of the sector address of the next write operation, and this length of time can brought as close as possible to 0.

The command codes of the former's write access command are “10H”, “41H” and “40H”, and those of the latter's write access command are “10H”, “40H” and “40H”. If the length of time T3 is brought close to 0, the length of time taken to enter a command for simultaneous two-bank parallel writing illustrated in FIG. 19 and that taken to enter a command for interleave write operation illustrated in FIG. 20 will become substantially equal. In short, the length of time taken by simultaneous two-bank parallel writing in FIG. 19 and that taken by interleave write operation in FIG. 20 can be 2T1+T2 at the minimum. By contrast, the minimum length of time taken to write into the two memory banks by one-bank operation illustrated in FIG. 18 will be 2T2 +2T1.

Therefore, as parallel writing or interleave write operation into the plurality of memory banks 3 and 4 is possible, the duration of a busy state due to write operation can be reduced. Though not illustrated, the same is true of erase operation.

[Chip layout] FIG. 21 shows a schematic plan of a typical chip layout of the flash memory. The memory bank 3 (Bank0) is configured the memory cell array 30 (0), the X address decoder 31 (0), the Y address decoder 32 (0), the Y switching circuit 33 (0), the sense latch circuit 34 (0) and the data latch circuit 35 (0). The memory bank 4 (Bank1) comprises the memory cell array 30 (1), the X address decoder 31 (1), the Y address decoder 32 (1), the Y switching circuit 33 (1), the sense latch circuit 34 (1) and the data latch circuit 35 (1). The substitution circuit 9 for the memory bank 3 is arranged adjacent to the memory bank 3, so that the route of transmission of the result of substitution determination by the substitution circuit 9 to the address decoders 31(0) and 32(0) of the memory bank 3 can be minimized in length. Similarly, the substitution circuit 10 for the memory bank 4 is arranged adjacent to the memory bank 4., so that the route of transmission of the result of substitution determination by the substitution circuit 10 to the address decoders 31(1) and 32(1) of the memory bank 4 can be minimized in length.

Reference numeral 40 in FIG. 21 generically denotes pad electrodes including input/output terminals I/O and the address buffer 11, and reference numeral 41 generically denotes internal circuits including the address counter 12 and the data input/output control circuit 22.

The flash memory 1 hitherto described can provide the following advantages.

The command decoder 20 and the CPU 21 cause status information indicating the status of memory operation in response to an instruction from outside to be reflected in the status registers 6 and 7 of the memory banks 3 and 4, and can supply outside the status information reflected in the status registers 6 and 7 from the input/output terminals I/O via the interface control unit 8 in accordance with an output instruction by the output enable signal /OE. This makes it possible to identify from outside the memory bank, in the multi-bank flash memory 1, in which an access error has arisen.

The command decoder 20, when abnormality in writing is notified by the status information items ST0 and ST1, accepts for the memory bank pertaining to that abnormality in writing only predetermined operational instructions specified for that memory bank, such as a write retry instruction specified for the memory bank pertaining to that abnormality, an operational instruction to reset the status register of the memory bank pertaining to that abnormality in writing, and a recovery read instruction specified for the memory bank pertaining to that abnormality in writing. This arrangement makes it possible, even if a write access error occurs in internal multiple banks, can provide protection against any inadequate instruction from a memory controller (controller for performing access control over the flash memory 1) to remedy that error, and thereby contribute to enhancing the reliability of memory operation and reducing the load on the memory controller.

Further, the command decoder 20, when abnormality in erasion is notified by the status information items ST0 and ST1, makes acceptable, for the memory bank pertaining to that abnormality in erasion, only predetermined ones out of operational instructions specified for that memory bank, such as a status register reset instruction to reset the status register of the memory bank pertaining to that abnormality in erasion. This arrangement makes it possible, even if an erase access error occurs in internal multiple banks, can provide protection against any inadequate instruction from the memory controller to remedy that error, and thereby contribute to enhancing the reliability of memory operation and reducing the load on the memory controller.

The command decoder 20 and the CPU 21 can perform an interleave operation by which, even during a memory operation in response to an instruction of write operation from outside designating one of the memory banks, memory operation in response to another instruction from outside of write operation designating another memory bank can be started, and parallel operation by which both memory banks are caused to perform write operations in parallel when, before a memory operation in response to an instruction of write operation designating one of the memory banks is started, another write operation designating another memory bank is instructed. Therefore, accessing for write operation or erase operation can be carried out on a plurality of memory banks in parallel. This feature makes it possible to reduce the duration of a busy state due to erase operation and write operation.

An access command to instruct parallel write operation differs from an access command to instruct interleave write operation only in the command code “41H”. For the command code “10H”, that command code “10H” and the command code “40H” are used in common. Therefore, even if the control form for parallel operation is adopted together with interleave operation on multiple banks, the increase in commands can be restrained, and accordingly the logical scale of command deciphering can be prevented from becoming too large.

In an erase operation where no Y address signal is required, a command format which needs, even where parallel erase operation is to be instructed, no delimiter code between the erase sector address for the memory bank 3 and the erase sector address for the memory banks 4 is adopted. This serves to restrain the increase in commands and to prevent the logical scale of command deciphering from becoming too large.

Although the invention made by the present inventor has been described in specific terms with reference to an embodiment thereof, obviously the invention is not confined to this embodiment, but can be varied in many different ways without deviating from its essentials.

For example, the nonvolatile memory cells are not limited to flash memory cells, but can as well be MNOSs, high dielectric memory cells or the like. The stored information in memory cells is not limited to two values per memory cell but may be multi-valued, such as four-valued, per cell. Also, the configuration of the memory cell array in the flash memory is not confined to the AND type, but can be appropriately altered to the NOR type, NAND type or the like. The definitions in respect of threshold voltage concerning erasion and writing can as well be reverse to those stated in this specification.

The status registers need not hold ready/busy information. The kinds of commands, the method of designating sector addresses, the method of entering write data and other aspects may be different from the foregoing description. For instance, the input terminals for data, addresses and commands need not be dedicated. The number of memory banks is not be restricted to two, but can be greater.

Advantages achieved by the invention disclosed in this application in its typical aspects will be briefly described below.

The memory bank in which an access error has occurred in a nonvolatile memory having multiple banks can be identified from outside.

Even if an access error, such as a write or erase error, occurs in any of internal multiple banks of a nonvolatile memory, protection can be provided against any inadequate instruction from the memory controller to remedy that error, and important contribution can be thereby made to enhancing the reliability of memory operation and reducing the load on the memory controller.

In a nonvolatile memory, such as a flash memory, having multiple banks, access operations such as write operation or erase operation can be provided in parallel on a plurality of memory banks.

In a nonvolatile memory, such as a nonvolatile memory, having multiple banks, the duration of a busy state due to erase operation and write operation can be reduced.

The logical scale of command deciphering from becoming too large in operating a plurality of memory banks in parallel, compared with accessing memory banks individually in a nonvolatile memory having multiple banks.

The present invention can be extensively applied to nonvolatile memories, including flash memories, EEPROMs and ferroelectric memories, which store information in two values or multiple values such as four values.

What is claimed is:

1. A nonvolatile memory comprising, on a semiconductor substrate, a plurality of memory banks including nonvolatile memory cells in which stored information is rewritable and each of which can perform memory operations independently of others, a control unit for controlling the memory operations on said plurality of memory banks, status registers of which one is provided for each of said memory banks, and an interface unit for interfacing with outside,
wherein said control unit controls the memory operations on each memory bank in accordance with operational instructions, causes status information indicating the status of memory operations to be reflected in the status register of the corresponding memory bank, and enables the status information reflected in said status register to be supplied externally from said interface unit.

2. The nonvolatile memory according to claim 1,
wherein an operation to erase stored information in nonvolatile memory cells, an operation to write information into the nonvolatile memory cells, and an operation to read stored information out of the nonvolatile memory cells are possible as said memory operations, and
wherein items of said status information include erase check information indicating the presence or absence of abnormal erase resulting in said erase operation and write check information indicating the presence or absence of abnormal write resulting in said write operation.

3. The nonvolatile memory according to claim 2, wherein said control unit, when said status information indicates abnormality in writing, makes acceptable, for the memory bank pertaining to that abnormality in writing, only predetermined ones out of instructions specified for that memory bank.

4. The nonvolatile memory according to claim 3, wherein said predetermined instructions include a write retry instruction by which the memory bank pertaining to the abnormality in writing is designated and a write operation is repeated and a status register reset instruction by which the status register of the memory bank pertaining to the abnormality in writing is reset.

5. The nonvolatile memory according to claim 4, wherein said predetermined instructions further include a recovery read instruction by which the memory bank pertaining to the abnormality in writing is designated and write data pertaining to the abnormality in writing are externally supplied.

6. The nonvolatile memory according to claim 2, wherein said control unit, when said status information indicates abnormality in erasion, makes acceptable, for the memory bank pertaining to that abnormality in erasion, only predetermined ones out of operational instructions specified for that memory bank.

7. The nonvolatile memory according to claim 6, wherein said predetermined instruction is a status register reset instruction by which the status register of the memory bank pertaining to the abnormality in erasion is reset.

8. The nonvolatile memory according to claim 1, wherein each of said memory banks has a substitution circuit for relieving nonvolatile memory cells contained in said memory bank from any defect that may have occurred.

9. A nonvolatile memory comprising, on a semiconductor substrate, a plurality of memory banks provided with nonvolatile memory cells in which stored information is rewritable and each of which can perform memory operations independently of others, and a control unit for controlling the memory operations on said plurality of memory banks,
wherein said control unit controls the memory operations on each memory bank in accordance with operational instructions, and is capable of controlling an interleave operation by which, even during a memory operation in response to an operational instruction designating one of the memory banks, a memory operation in response to another operational instruction designating another memory bank can be started, and a parallel operation by which both memory banks are caused to perform memory operations in parallel when, before a memory operation in response to an operational instruction designating one of the memory banks is started, another memory operation designating another memory bank is instructed.

10. The nonvolatile memory according to claim 9,
wherein an operation to erase stored information in nonvolatile memory cells, an operation to write information into the nonvolatile memory cells, and an operation to read stored information out of the nonvolatile memory cells are possible as said memory operations, and
wherein said interleave operation and parallel operation are made possible for said instruction of an erase operation or for instruction of a write operation.

11. The nonvolatile memory according to claim 10, wherein said control unit determines, for an instruction of a write operation, whether to make possible said interleave operation or to make possible said parallel operation according to a difference in command code.

12. The nonvolatile memory according to claim 10, wherein said control unit determines, for an instruction of an erase operation, whether to make possible said interleave operation or to make possible said parallel operation according to whether only one memory bank or a plurality of memory banks are designated.

13. A nonvolatile memory comprising, on a semiconductor substrate, a plurality of memory banks provided with nonvolatile memory cells in which stored information is rewritable and each of which can perform memory operations independently of others, and a control unit for controlling the memory operations on said plurality of memory banks in accordance with access commands from outside,
wherein said access commands include a first access command and a second access command,
wherein said first access command includes a first command code, address information designating an address in one of the memory banks, a second command code, address information designating an address in another memory bank, and said second command code,
wherein said second access command includes a first command code, address information designating an address in one of the memory banks, a third command code, address information designating an address in another memory bank, and said second command code, and
wherein said control unit starts, in response to the inputting of said second command code, a memory operation on the memory bank designated by said address information.

14. The nonvolatile memory according to claim 13,
wherein an operation to erase stored information in nonvolatile memory cells, an operation to write information into the nonvolatile memory cells, and an operation to read stored information out of the nonvolatile memory cells are possible as said memory operations, and
wherein said first command code is a command code to represent the type of the write operation, and said second command code is a command code to instruct the start of the write operation.

15. A nonvolatile memory comprising, on a semiconductor substrate, a plurality of memory banks provided with nonvolatile memory cells in which stored information is rewritable and each of which can perform memory operations independently of others, and a control unit for controlling the memory operations on said plurality of memory banks in accordance with access commands from outside,
wherein said access commands include a third access command and a fourth access command,
wherein said third access command includes a fourth command code, address information designating an address in one of the memory banks, and a fifth command code,
wherein said fourth access command includes a fourth command code, address information designating an address in one of the memory banks, address information designating an address in another memory bank, and said fifth command code, and
wherein said control unit starts, in response to the inputting of said fifth command code, a memory operation on the memory bank designated by said address information.

16. The nonvolatile memory according to claim 15,
wherein an operation to erase stored information in nonvolatile memory cells, an operation to write information into the nonvolatile memory cells, and an operation to read stored information out of the nonvolatile memory cells are possible as said memory operations, and
wherein said fourth command code is a command code to instruct an erase operation, and the fifth command code is a command code to instruct the start of an erase operation.
